(19) United States
(12) Patent Application Publication
(10) Pub. No.: US 2021/0016592 A1
(43) Pub. Date: Jan. 21, 2021

(54) METHOD OF PROVIDING A SECURITY ELEMENT ON A SECURITY DOCUMENT BY LASER MARKING

(71) Applicant: AGFA-GEVAERT NV, Mortsel (BE)

(72) Inventors: Nick VALCKX, Mortsel (BE); Rene GEELEN, Mortsel (BE); Jürgen JUNG, Mortsel (BE)

(21) Appl. No.: 16/766,821

(22) PCT Filed: Nov. 27, 2018
(86) PCT No.: PCT/EP2018/082623

§ 371 Date: May 26, 2020

(30) Foreign Application Priority Data
Nov. 27, 2017 (EP) 17203914.1

(51) Int. Cl. B42D 25/41; B41M 3/14; B41M 5/26; B42D 25/324

(52) U.S. Cl. CPC B42D 25/41; B42D 25/324; B41M 5/267; B41M 3/14

(57) ABSTRACT

A method of providing an Optical Variable Device (OVD) and a tactile security element on a security document includes exposing the security document with a laser. The security document includes an overlay provided on a core, and the overlay includes a compound capable or releasing a gas. The OVD and the tactile security element have a metallic appearance.

### CROSS REFERENCE TO RELATED APPLICATIONS

This application is a 371 National Stage Application of PCT/EP2018/082623, filed Nov. 27, 2018. This application claims the benefit of European Application No. 17203914.1, filed Nov. 27, 2017, which is incorporated by reference herein in its entirety.

### BACKGROUND OF THE INVENTION

### 1. Field of the Invention

This invention relates to a method of providing a security element on a security document by laser marking. The method enables the provision of an OVD and/or a tactile security element on a security document.

### 2. Description of the Related Art

Security documents, in particular security cards are widely used for various applications such as identification purposes (ID cards) and financial transfers (credit cards). Such cards typically consist of a laminated structure consisting of various plastic lamellae and layers wherein one or more of them carry visible information, such as alphanumeric information, logos and a picture of the card holder, and optionally also digital information stored in a magnetic strip or in an electronic chip (so-called smart card).

A principal objective of security documents is that they cannot be easily modified or reproduced in such a way that the modification or reproduction is difficult to distinguish from the original. For this reason, one or more security elements are incorporated in such security documents, which are difficult to reproduce.

WO2011/124485 and WO2013/037651, both from Agfa Gevaert, disclose a security document comprising a core and an overlay provided on the core. The overlay, referred to as a security laminate, comprises a biaxially stretched polyethylene terephthalate (PET) support and one or more coatings provided on the PET support.

Embossing is typically applied on cards, for example credit cards, to create a 3-D font, which stands out against its background and highlights required card details. The raised fonts may be further coated with white, black, silver or golden paint for an enhanced visual contrast.

So called Optical Variable Devices (OVDs), which change their appearance when viewed in different directions, are often used as an anti-counterfeiting security element on banknotes, credit cards and government issued identification cards. OVDs cannot be photocopied or scanned, nor can they be accurately replicated or reproduced.

Such OVDs may contain metallic layers as disclosed in for example WO2006/024478 (OVD Kinegram).

Optical variable inks (OVIs) may also be used to provide security features on security documents. An image printed with such OVIs typically displays two distinct colours depending on the viewing angle. OVIs and their use disclosed in for example EP-A 227423 (Flex Products).

Images having a metallic appearance are often used in security documents as security feature. Such images are difficult to alter or to reproduce and render the security documents therefore more difficult to counterfeit. Moreover, such images may not be copied.

The incorporation of images having a metallic appearance in a security document may however involve complex preparation methods.

There is a need for more efficient, less complex methods to provide an OVD and/or a tactile security element having a metallic appearance on security documents.

### SUMMARY OF THE INVENTION

It is an object of the present invention to provide a cost effective and/or efficient method of providing an OVD and/or a tactile security element on a security document, wherein the OVD and the tactile security element have a metallic appearance, are difficult to reproduce and created inside the security document.

This object is realized by the method defined below.

Further advantages and embodiments of the present invention will become apparent from the following description.

### BRIEF DESCRIPTION OF THE DRAWINGS

FIG. 1 shows a schematic representation of an embodiment of a security document used in the method of the invention.

FIG. 2 shows a schematic representation of another embodiment of a security document used in the method of the invention.

FIG. 3 shows a schematic representation of still another embodiment of a security document used in the method of the invention.

FIGS. 4a and 4b show a schematic representation of an embodiment of a laser marked OVD in a security document. The laser marked OVD comprises two images. A first image represents a rhombus, a second image represents characters (“agfa”) inside the rhombus. The OVD observed at a first viewing angle is shown in FIG. 4a and at a second viewing angle in FIG. 4b.

FIG. 5 shows a schematic representation of the image set-up to evaluate the laser marked OVD's on a security card.

FIG. 6 shows an area of a tactile security element of which the height is measured by profilometry in Example 1.

FIG. 7 shown an area of a tactile security element of which the height is measured by profilometry in Example 1.

FIGS. 8a and 8b shown the areas of interest (AOI's) used to evaluate the laser marked OVD on SD-30 in example 4 at two viewing angles.

FIG. 9 shows the angular ratio curves of an OVD laser marked on SD-30 to SD-33 of example 4.

FIG. 10 shows a profile of the height of the tactile security element shown in FIG. 7.

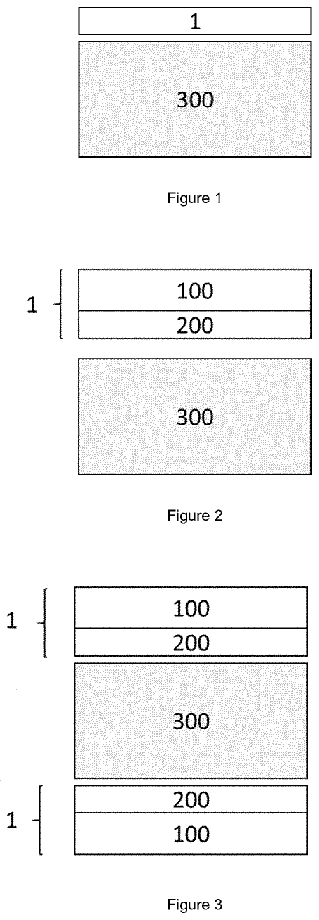

### DETAILED DESCRIPTION OF THE PREFERRED EMBODIMENTS

### Definitions

The terms “support” and “foil”, as used in disclosing the present invention, mean a self-supporting polymer-based sheet, which may be associated with one or more subbing layers. Supports and foils are usually manufactured through (co-)extrusion of polymer(s).

The term “layer”, as used in disclosing the present invention, is considered not to be self-supporting and is manufactured by coating it on a support or a foil.

The term “lamella”, as used in disclosing the present invention, includes one or more foils and one or more layers.

“PET” is an abbreviation for polyethylene terephthalate.

“PETG” is an abbreviation for polyethylene terephthalate glycol, the glycol indicating glycol modifiers which are incorporated to minimize brittleness and premature aging that occur if unmodified amorphous polyethylene terephthalate (APET) would be used in the production of cards.

“PET-C” is an abbreviation for crystalline PET, i.e. an oriented polyethylene terephthalate. Such a polyethylene terephthalate support has excellent properties of dimensional stability.

The definitions of security features correspond with the normal definition as adhered to in the “Glossary of Security Documents—Security features and other related technical terms” as published by the Consilium of the Council of the European Union on Aug. 25, 2008 (Version: v.10329.02.b.en) on its website: http://www.consilium.europa.eu/prado/EN/glossaryPopup.html.

The term “alkyl” means all variants possible for each number of carbon atoms in the alkyl group i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

### Method of Providing an OVD on a Security Document by Laser Marking

The method of providing an OVD or a tactile security element on a security document according to the present invention comprises the step of exposing the security document with a laser, the security document comprising an overlay (1) provided on a core (300), characterized in that the overlay comprises a component capable of forming a gas upon laser exposure.

In a preferred embodiment, the overlay (1) provided on the core (300) comprises a layer (200) including the component capable of forming a gas upon laser exposure provided on a support (100).

### Optical Variable Device

An Optically Variable Device (OVD) is a security feature whose appearance changes as function of viewing conditions. The OVD itself does not change, but how it interacts with light and viewing conditions makes it seem to vary to an observer. For example, the appearance of the OVD may change as function of the viewing angle.

The appearance of the OVD prepared with the method according to the invention indeed changes as function of the viewing angle. The OVD has a gloss structure, which varies as function of the viewing angle. The gloss structure is the result of small areas, referred to herein as gloss structure elements, which have a higher gloss than other areas, under a given viewing angle.

This gloss structure, which varies as function of the viewing angle, gives the OVD a metallic appearance.

The laser marked OVD typically includes several images. Such images may be characters, pictures, photographs, logo's, drawings, line patterns, guilloches, etc.

These images may be superposed on each other. For example, characters may be provided inside a logo. Also, the OVD may include such images provided on a laser marked background.

It has now been observed that the appearance of the images may change as function of the viewing angle. An image, for example characters, may even become invisible or almost invisible, when viewed under a particular viewing angle.

Moreover, it has been observed that the appearance of different images making up the OVD change differently relative to each other as function of the viewing angle.

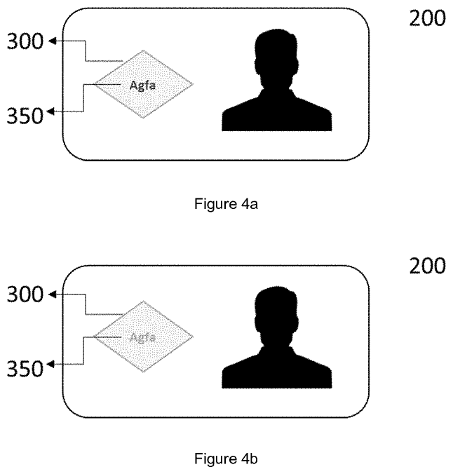

This is illustrated in FIG. 4. A security card (200) comprises a laser marked OVD including characters (300) on a background (350). The characters are easy to read when the security card is viewed under a first viewing angle (FIG. 4a), while the characters are difficult to read, or even invisible, when the security is viewed under a second viewing angle (FIG. 4b).

An OVD obtained with the method according to the present invention may be characterized by measuring the difference of grey level between two areas of the OVD, as function of viewing angle.

To characterize the OVD provided by the method of the present invention, the following definitions are used hereinafter:

Relative angle is the angle between the direction of illumination and the direction of observation. The relative angle may also be referred to as viewing angle.

AOI is an area-of-interest in the OVD, for example the rhombus (300) and the characters “Agfa” (350) inside the rhombus on the security card (200) in FIG. 4.

The AOI is also referred to as an image in the text and claims herein.

Grey level is the average grey level of the AOI.

In an Angular scan the average grey level of the AOI's are measured at different relative angles.

An Angular ratio curve consists of the ratio of the grey levels of the AOI's at different relative angles.

When the ratio of the grey levels of the AOI's differs at different relative angles, the visibility of the AOI's relative to each other changes as function of the relative angle, thus the viewing angle.

For example, the ratio of the grey level of the rhombus (300) and the characters “Agfa” (350) inside the rhombus is different in FIG. 4a compared to those in FIG. 4b. For the security document in FIG. 4a the ratio between both AOI's is larger compared to the ratio of both AOI's for the security document in FIG. 4b. This means that the characters of the OVD on the security document in FIG. 4b are less visible (relative to the Rhombus) compared to those of the security document shown in FIG. 4a.

Preferably, the ratio of the grey level at two relative angles (or viewing angles) of two AOI's of the OVD differs more than 0.3, more preferably more than 0.4, most preferably more than 0.5.

In a particular preferred embodiment, when evaluating the ratio of the grey level of two AOI's as function of the relative angle (or viewing angle), the OVD has both a ratio above 1 and a ratio below 1, more preferably above 1.1 and below 0.9, most preferably above 1.2 and below 0.8.

This means that a first AOI or image is brighter than a second AOI or image at a first viewing angle and that the first AOI or image becomes less brighter than the second AOI or image at a second viewing angle. This may be referred to as a flip-flop of brightness as function of the relative angle or viewing angle.

The OVD prepared according to the present invention preferably comprises two, three, or more different images, images such as described above. All such images making up the OVD are preferably laser marked.

The OVD preferably contains line patterns or drawings, which emphasize the “OVD” character, i.e. changing of the appearance of the OVD as function of the viewing angle.

The laser marked OVD may however also be combined with images produced with other marking or printing techniques.

The OVD preferably comprises so-called fixed and variable data. The method according to the present invention makes it possible to realize an OVD wherein the appearance of fixed data and of variable data changes, also relative to each other, as function of the viewing angle.

Preferably, the security document used on the method according to the invention has a glossy surface, i.e. a surface having a 60° gloss value in the range 70-85 GU, or a high glossy surface, i.e. a surface having a 60° gloss value of more than 85 GU). However, the method may still be used with security documents having a semi-gloss surface, i.e. a surface having a 60° gloss value in the range 35-70 GU, and even with a surface having a ‘satin-like’ gloss finish, i.e. a surface having a 60° gloss value in the range 20-35 GU (See ASTM D 523 for a definition of gloss measurements).

Providing an OVD on a security document my means of laser marking enables to formation of the OVD “inside” the security document.

For example in the embodiment shown in FIGS. 2 and 3, wherein the security document comprises an overlay (1) provided on a core (300), and wherein the overlay comprises an adhesive layer (200) provided on a transparent support (100), laser marking is carried out through the transparent support. The laser marked OVD is then formed in the adhesive layer, or at the interface of the adhesive layer and the core, the support, or another layer on the adhesive layer. The surface of the security document, i.e. the outer surface of the support (100), is thus not altered upon laser exposure. This results in the absence of a haptic differentiation between the OVD and non-exposed areas of the security document.

The fact that the OVD is formed “inside” the security document makes it even more difficult to counterfeit. In addition, the OVD is protected from the environment.

Providing an OVD by laser marking also has the advantage that the OVD may be applied at the very end of the manufacturing process of the security document, enabling more flexibility with respect to the content of the OVD to be provided on the security document.

In the method of the present invention, the OVD may be created during the personalization step after lamination of the overlay on the core, and not prior to the lamination.

In addition, the OVD may be personalized by laser marking, making it even harder to counterfeit. Examples of such OVDs are card number, names, pictures, etc.

Also, the OVD may be the ghost image or watermark of the picture of the card holder. In another example, the OVD may be the contour of a country, in which personalization can be done through card number, name of the card holder, location, etc.

The OVD may also comprise a QR code.

The gloss structure of the OVD may be isotropic or non-isotropic by selection of appropriate laser marking parameters. Examples of non-isotropic OVD include formation of lines of gloss structural elements or laser marking a gloss dithering pattern.

The OVD produced by the method of the invention preferably has a colour density.

In principle any colour may be formed, however a neutral (grey) colour is preferred.

The OVD preferably has a metallic look, i.e. having a colour comparable to the colour of for example platinum, silver or aluminium. Therefore, the L* value of the OVD is preferably between 30 to 80, more preferably between 40 to 70, most preferably between 55 and 65.

The difference in visual density between the OVD and non-exposed areas of the security document (delta Dvis) is preferably at least 0.15, more preferably at least 0.30, most preferably at least 0.50. The delta Dvis has to be high enough to be viewed by the observer. However, a too high density may disguise the gloss structure of the OVD and may need a too high laser energy. Also, when delta Dvis is too low or too high, simulating a metallic look becomes less obvious. Therefore, the delta Dvis is preferably below 2.00, more preferably below 1.50, most preferably below 1.00.

For obtaining a colour different from grey, colour forming agents, such as leuco dyes, are preferably added to the overlay. However, the overlay preferably does not contain a substantial amount of leuco dye, most preferably the overlay does not contain a leuco dye.

Colour differences between imaged and non-imaged areas are measured with a spectrophotometer having a 45°/0° geometry and are expressed in delta Dvis, which is the difference of visual density Dvis of both areas under comparison. Dvis is evaluated using the visual brightness curve as weighting function (V_{λ}=CIE colour matching function “y bar” for 2 degree observer).

### Tactile Security Element

It has been observed that, upon proper optimization of the laser exposure, the method according to the present invention may be used to provide tactile security elements on a security document.

A tactile security element as referred to herein means a security element that can be perceived via touch, for example using one or more fingers.

The tactile security element preferably has a height above 15 μm, more preferably above 50μ, most preferably above 75 μm.

The method according to the present invention makes it thus possible to create tactile images on a security document, for example credit cards, that are typically created with embossing techniques.

The method according to the present invention makes it also possible to produce tactile security elements having a height above 100 μm, or even above 150 μm or 200 μm. This means that the method according to the present invention may be used to produce braille characters or tactile information that may be used in pharmaceutical applications.

The tactile security element preferably has a metallic appearance. More preferably, the tactile security element has OVD character, i.e. its appearance changes with viewing angle. The tactile security element is thus preferable a tactile OVD.

It has been observed that the height of the security element may increase upon increasing the laser energy used to laser mark.

The security element produced with the method according to the present invention on a security document may comprise both non-tactile OVD's and tactile security elements.

It has been observed that using the same laser, non-tactile OVD's, tactile OVD's and tactile security elements may be produced on the security document by optimizing the laser parameters for the different security elements.

Typically, for producing the non-tactile OVD's or tactile security elements a higher laser energy density is used. Or, tactile security elements may be produced by exposing the same security element more than once, for example twice or three times.

### Overlay

The overlay comprises a compound capable or releasing a gas upon laser exposure.

In a preferred embodiment, the overlay (10) comprises an adhesive layer (100) provided on a support (200), the adhesive layer including the compound capable or releasing a gas upon laser exposure.

The overlay according to this embodiment is then preferably laminated on the core (300), thereby forming the security document.

The overlay may be laminated on one or both sides of the core, as shown in FIG. 2.

In another embodiment, the adhesive layer (100) containing the halogenated co- or homopolymer is coated directly on the core. The coating composition of the adhesive layer can be coated using any conventional coating technique, such as dip coating, knife coating, extrusion coating, spin coating, slide hopper coating and curtain coating on the support.

Another layer or foil may then be applied on the coated adhesive layer.

In still another embodiment, the overlay (10) is co-extruded together with the core.

### Compound Capable of Releasing a Gas Upon Laser Exposure

In principle any compound capable of releasing a gas upon laser exposure may be used.

The compound is preferable a halogenated co- or homopolymer.

The halogenated co- or homopolymer is preferably a chlorinated of fluorinated co- or homopolymer.

Preferred chlorinated of fluorinated co- or homopolymers are based on the polyethylene structure, where hydrogen atoms are replaced by the halogen atoms.

Preferred chlorinated co- or homopolymers are co- or homopolymers of vinylchloride, vinylidenechloride, or chloroprene.

Preferred fluorinated co- or homopolymers are co- or homopolymers of tetrafluoroethylene, vinylfluoride, or chlorotrifluoroethylene.

In a most preferred embodiment, the halogenated co- or homopolymer is a co- or homopolymer of vinylchloride.

A highly preferred vinylchloride copolymer is a copolymer of vinylchloride and vinylacetate.

The vinylchloride-vinylacetate copolymer preferably also comprise a hydroxyl functional monomer. The hydroxyl functional monomer is preferably selected from the group consisting of vinyl alcohol, hydroxypropyl acrylate, hydroxyethyl acrylate, and hydroxyethyl-methacrylate.

The amount of vinyl chloride is preferably at least 85 wt % of vinyl chloride, more preferably at least 90 wt % of vinyl chloride and most preferably at least 92 wt % of vinyl chloride based on the total weight of the polymer.

Preferred copolymers of vinylchloride and vinylacetate are the Solbin® resins commercially available from Shin Etsu such as for example: Solbin® A, which is a copolymer of 92 wt % vinylchloride, 3 wt % vinylacetate, 5 wt % vinylalchohol; Solbin® AL, which is a copolymer of 93 wt % vinylchloride, 2 wt % vinylacetate, 5 wt % vinylalchohol; Solbin® TA2, which is a copolymer of 83 wt % vinylchloride, 4 wt % vinylacetate, 13 wt % hydroxyalkyl acrylate; Solbin® TA3, which is a copolymer of 83 wt % vinylchloride, 4 wt % vinylacetate, 13 wt % hydroxyalkylacrylate, Solbin® TAO, which is a copolymer of 91 wt % vinylchloride, 2 wt % vinylacetate, 7 wt % vinyl alcohol.

Other preferred copolymers of vinylchloride and vinylacetate are the Vinnol® type resins from Wacker Chemie such as for example Vinnol® H 5/50 A, which is a copolymer of 90 wt % vinylchloride, 4 wt % vinylacetate, 6 wt % vinyl alcohol.

Still other preferred copolymers of vinylchloride and vinylacetate are the Sunvac® type resins from Yantai Suny Chem International such as for example: Sunvac® GH, which is a copolymer of 90 wt % vinylchloride, 4 wt % vinylacetate, 6 wt % vinyl alcohol; Sunvac® GF, which is a copolymer of 81 wt % vinylchloride, 4 wt % vinylacetate, 15 wt % hydroxylalkyl acrylate; and Sunvac® OH, which is a copolymer of 81 wt % vinylchloride, 4 wt % vinylacetate, 15 wt % hydroxylalkyl acrylate.

According to another embodiment, the compound capable of releasing a gas is a so-called blowing agent.

A blowing agent is a chemical added to plastics and rubbers that generates inert gases on heating. It is normally used for causing the resin to assume a cellular structure. In the present invention it was observed that the use of a blowing agent reduced the maximum optical density obtainable with the second laser markable layer even further.

Suitable blowing agents include those in U.S. Pat. No. 4,737,523 (MOBAY), U.S. Pat. No. 4,728,673 (BAYER), U.S. Pat. No. 4,683,247 (GENERAL ELECTRIC), U.S. Pat. No. 4,616,042 (GENERAL ELECTRIC), U.S. Pat. No. 4,587,272 (GENERAL ELECTRIC) and U.S. Pat. No. 4,544,677 (GENERAL ELECTRIC), which are hereby incorporated by reference.

Preferred blowing agents according to the present invention have gas generation temperatures measured at standard pressure of at least 10° C. above the lamination temperature of the second laser markable layer.

In a preferred embodiment, the gas generation temperature measured at standard pressure of the blowing agent is at least 180° C., more preferably at least 200° C.

Some exemplary blowing agents useful in the practice of the present invention include nitroso compounds, semicarbazide compounds, tetrazole compounds, oxalate compounds, triazine compounds, dihvdrooxadiazinione compounds and combinations thereof. Particularly preferred compounds include 5-pheny-3,6-dihydro-1,3,4-oxadiazin-2-one (“PDOX”) and 5-phenyl tetrazole.

5-phenyl tetrazole is particularly preferred because at a lamination temperature of 160° C. no blowing-effect is observed.

The blowing agent is preferably used in a concentration of up to 15 wt % %, based on the total weight of the laser markable polymer(s).

### Support

The overlay preferably comprises a support (FIG. 2, 100), more preferably a transparent polymeric support.

Suitable transparent polymeric supports include cellulose acetate propionate or cellulose acetate butyrate, polyesters such as polyethylene terephthalate and polyethylene naphthalate, polyamides, polycarbonates, polyimides, polyolefins, polyvinylchlorides, polyvinylacetals, polyethers and polysulphonamides.

The support is preferably an oriented polyester support. Orienting a polyester support is achieved by stretching the support in a longitudinal direction, a transversal direction or both directions. The highest crystallinity of the polyester support is obtained by biaxially stretching.

The polyester is preferably biaxially stretched with a stretching factor of at least 2.0, more preferably at least 3.0 and most preferably a stretching factor of about 3.5. The temperature used during stretching is preferably at least 100° C., more preferably at least 140° C. and most preferably about 160° C.

The oriented polyester support is preferably a polyethylene terephthalate or a polyethylene napthalate support.

In the most preferred embodiment, the oriented polyester support is a biaxially stretched polyethylene terephthalate support. Such a polyethylene terephthalate support has excellent properties of dimensional stability and is very durable and resistant to scratches and chemical substances.

The biaxially stretched polyethylene terephthalate substrate should be sufficiently thick to be self-supporting, but thin enough to be flexed, folded or creased without cracking. Preferably, the biaxially stretched polyethylene terephthalate substrate has a thickness of between about 7 μm and about 100 μm, more preferably between about 10 μm and about 90 μm, most preferably between about 25 μm and about 80 μm.

The manufacturing of PET-C foils and supports is well-known in the art of preparing suitable supports for silver halide photographic films. For example, GB 811066 (ICI) teaches a process to produce biaxially oriented polyethylene terephthalate foils and supports.

The support preferably comprises subbing layers to improve the adhesion between the support and layers provided thereon.

### Subbing Layers

The support (100) preferably comprises subbing layers to improve the adhesion between the support and layers provided thereon.

Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

Suitable vinylidene chloride copolymers include: the copolymer of vinylidene chloride, N-tert.-butylacrylamide, n-butyl acrylate, and N-vinyl pyrrolidone (e.g. 70:23:3:4), the copolymer of vinylidene chloride, N-tert.-butylacrylamide, n-butyl acrylate, and itaconic acid (e.g. 70:21:5:2), the copolymer of vinylidene chloride, N-tert.-butylacrylamide, and itaconic acid (e.g. 88:10:2), the copolymer of vinylidene chloride, n-butylmaleimide, and itaconic acid (e.g. 90:8:2), the copolymer of vinyl chloride, vinylidene chloride, and methacrylic acid (e.g. 65:30:5), the copolymer of vinylidene chloride, vinyl chloride, and itaconic acid (e.g. 70:26:4), the copolymer of vinyl chloride, n-butyl acrylate, and itaconic acid (e.g. 66:30:4), the copolymer of vinylidene chloride, n-butyl acrylate, and itaconic acid (e.g. 80:18:2), the copolymer of vinylidene chloride, methyl acrylate, and itaconic acid (e.g. 90:8:2), the copolymer of vinyl chloride, vinylidene chloride, N-tert.-butylacrylamide, and itaconic acid (e.g. 50:30:18:2). All the ratios given between brackets in the above-mentioned copolymers are ratios by weight.

In a preferred embodiment, the support is provided with a subbing layer including a copolymer selected from the group consisting of a hydroxyl-functional, partially-hydrolyzed vinyl chloride/vinyl acetate copolymer and a polyester-urethane.

In a particular preferred embodiment, the support is provided with a subbing layer including a binder based on a polyester-urethane copolymer.

In a more preferred embodiment, the polyester-urethane copolymer is an ionomer type polyester urethane, preferably using polyester segments based on terephthalic acid and ethylene glycol and hexamethylene diisocyanate.

A suitable polyester-urethane copolymer is Hydran™ APX101H from DIC Europe GmbH.

The application of subbing layers is well-known in the art of manufacturing polyester supports for silver halide photographic films. For example, the preparation of such subbing layers is disclosed in U.S. Pat. No. 3,649,336 (AGFA) and GB 1441591 (AGFA).

In a preferred embodiment, the subbing layer has a dry thickness of no more than 2 μm or preferably no more than 200 mg/m².

A preferred method of providing the subbing layers on the support is disclosed in EP-A 2374602 an EP-A 2567812, both from Agfa Gevaert.

A preferred method comprises the steps of a) stretching a polyester substrate in either a longitudinal or a transversal direction; b) coating and drying a subbing layer on the stretched polyester substrate; c) stretching the coated polyester substrate in the longitudinal or transversal direction not selected in step a) in order to obtain a coated biaxially stretched polyester substrate having a subbing layer.

### Adhesive Layer

The overlay preferably comprises an adhesive layer.

The adhesive layer preferably comprises the halogenated co- or homopolymer described above as a first polymer.

The adhesive layer may further comprise a second polymer.

In a preferred embodiment, the second polymer is a copolymer of vinyl butyral, vinyl acetate and vinyl alcohol containing preferably at least 60 mol % of vinyl butyral, more preferably at least 65 mol % of vinyl butyral and most preferably at least 70 mol % of vinyl butyral and preferably at most 40 mol % of vinyl alcohol, more preferably at most 30 mol % of vinyl alcohol and most preferably at most 26 mol % of vinyl alcohol. The vinyl acetate content in the second polymer is preferably at most 5 mol %, more preferably at most 3 mol %.

Suitable copolymers of vinyl butyral, vinyl acetate and vinyl alcohol are the S-Lec™ grades from SEKISUI.

In another preferred embodiment, the second polymer is a copolymer of styrene, butadiene and methylmethacrylate. A suitable copolymer of styrene, butadiene and methylmethacrylate is Zylar™ 631 from INEOS.

The total amount of polymeric binder of the adhesive layer is preferably between 3 and 30 g/m², more preferably between 5 to 20 g/m².

In a preferred embodiment, the thickness of the adhesive layer is between 1 μm and 12 μm.

As described above, the adhesive layer comprising the halogenated co- or homopolymer may be coated on a support (100) to form an overlay, which is then laminated on a core (300), or the adhesive layer is coated directly on a core.

The coating composition of the adhesive layer can be coated using any conventional coating technique, such as dip coating, knife coating, extrusion coating, spin coating, slide hopper coating and curtain coating on the support.

The coating composition of the adhesion layer may contain one or more organic solvents. A preferred organic solvent is methylethylketone (MEK) because it combines a high solubilizing power for a wide range of ingredients and it provides a good compromise between the fast drying of the coated layer and the danger of fire or explosion thereby allowing high coating speeds.

The adhesive layer may however also be coated from an aqueous coating solution. Such aqueous coating solution are often preferred for health and safety reasons.

For such aqueous coating solutions, watersoluble or waterdispersible halogenated co- or homopolymers are preferably used. An example of an aqueous polyvinylchloride dispersion is SolVin 068SA. Examples of aqueous polyvinylidene dispersions are the DARAN® PVCD dispersions from Owensboro Specialty Polymers and the DIOFAN® PVDC dispersions from Solvay.

A preferred overlay comprising an adhesive layer, and its preparation method is disclosed in WO2011/124485 and WO2013/037651, both from Agfa Gevaert.

### Laser Additives

The security document may include a so-called laser additive, which renders the security document more sensitive to laser radiation, i.e. the OVD may then be formed at lower laser exposures, or higher visual densities are obtained.

The laser additive may be added to the core of the security document, however it is preferably added to the overlay, more preferably to the adhesive layer of the overlay.

It is however important that the laser additive does not impart unwanted background colouration to the security document. This may realized by using only small amounts of the laser additive and/or selecting laser additives that has minimal absorption in the visible region of the spectrum.

Suitable laser additives include antimony metal, antimony oxide, carbon black, mica (sheet silicate) coated with metal oxides and tin-antimony mixed oxides. In WO 2006/042714, the dark coloration of plastics is obtained by the use of additives based on various phosphorus-containing mixed oxides of iron, copper, tin and/or antimony.

Suitable commercially available laser additives include mica coated with antimony-doped tin oxide sold under the trade name of Lazerflair™ 820 and 825 by MERCK; copper hydroxide phosphate sold under the trade name of Fabulase™ 322 by BUDENHEIM; aluminium heptamolybdate sold under the trade name of AOM™ by HC STARCK; and antimony-doped tin oxide pigments such as Engelhard Mark-It™ sold by BASF.

In a preferred embodiment the laser additive is carbon black. This avoids the use of heavy metals in manufacturing these security documents. Heavy metals are less desirable from an ecology point of view and may also cause problems for persons having a contact allergy based on heavy metals.

Suitable carbon blacks include Special Black 25, Special Black 55, Special Black 250 and Farbruss™ FW2V all available from EVONIK; Monarch™ 1000 and Monarch™ 1300 available from SEPULCHRE; and Conductex™ 975 Ultra Powder available from COLUMBIAN CHEMICALS CO.

The use of carbon black pigments as laser additives may lead to an undesired background colouring of the security document precursor. For example, a too high concentration of carbon black in the adhesive layer of the security document having a white core may result in grey security documents. For that reason it is preferred to use carbon black particles having a numeric average particle size smaller than 300 nm, preferably between 5 nm and 250 nm, more preferably between 10 nm and 100 nm and most preferably between 30 nm and 60 nm. The average particle size of carbon black particles can be determined with a Brookhaven Instruments Particle Sizer BI90plus based upon the principle of dynamic light scattering.

Infrared absorbing dyes having substantial no absorption in the visible region may also be used as laser additives. Such dyes, as disclosed in for example WO2014/057018 (Agfa Gevaert), are particular suitable for use with a NIR laser, for example with a 1064 nm laser.

In a preferred embodiment no or a minimal amount of laser additives are added to the core or the overlay. The amount of the laser additive in the core or the adhesive layer of the overlay is preferably less than 1000 ppm, more preferably less than 100, most preferably less than 10 ppm.

The adhesive layer of the overlay may include other ingredients, for example surfactants to enhance the coating quality. The surfactant is preferably an anionic or non-ionic surfactant.

### Outer Layer

The overlay may also comprise an outer layer provided at a side of the support opposite to the side of the support upon which the adhesive layer is provided.

Such an outer layer is preferably an ink receiving layer or a receiver layer for Dye Diffusion Thermal Transfer (D2T2) printing.

The presence of such a layer enables the addition of information or other security information to the security document by for example inkjet printing or D2T2 printing.

### Core

The security document comprises a core.

The core can be transparent, translucent or opaque.

The core is preferably opaque. The advantage of an opaque core, preferably of a white colour, is that any information of the security document is more easily readable and that a colour image is more appealing by having a white background.

Suitable polymers for the core of the security document include cellulose acetate propionate or cellulose acetate butyrate, polyesters such as polyethylene terephthalate and polyethylene naphthalate, polyamides, polycarbonates, polyimides, polyolefins, polyvinyl chlorides, polyvinylacetals, polyethers and polysulphonamides.

Preferred polymeric cores are based on polycarbonate (PC), polyvinylchloride (PVC), and polyethylene terephthalate (PET).

Other preferred cores are based on so-called synthetic papers such as Synaps™ or Teslin® synthetic papers, respectively from Agfa Gevaert and Teslin.

The core may also be based on paper, such as polyethylene or propylene coated paper.

The core may be a single component extrudate, but can also be co-extrudate.

Examples of suitable co-extrudates are PET/PETG and PET/PC.

Instead of a coloured or whitened support, an opacifying layer can be coated onto a transparent support. Such opacifying layer preferably contains a white pigment with a refractive index greater than 1.60, preferably greater than 2.00, and most preferably greater than 2.60. The white pigments may be employed singly or in combination. Suitable white pigments include C.I. Pigment White 1, 3, 4, 5, 6, 7, 10, 11, 12, 14, 17, 18, 19, 21, 24, 25, 27, 28 and 32. Preferably titanium dioxide is used as pigment with a refractive index greater than 1.60. Titanium oxide occurs in the crystalline forms of anatase type, rutile type and brookite type. In the present invention the rutile type is preferred because it has a very high refractive index, exhibiting a high covering power.

Methods to obtain opaque polyethylene terephthalate and biaxially oriented films thereof of have been disclosed in, e.g. US 2008238086 (AGFA).

### Security Document

The security document referred to herein may be any security document, i.e. a document, which is to be difficult to counterfeit. Such documents may be official documents like ones driver licence, passport, or identity card.

The security document may however also be a banknote or a packaging, the latter containing security features to prevent counterfeiting of the packaged goods.

Preferred security documents are security cards, which are widely used for various applications such as identification purposes (ID cards) and financial transfers (credit cards).

The security document may include an electronic chip and optionally an antenna.

In a preferred embodiment the security document is a so-called radio frequency identification card or RFID-card.

In addition to the OVD provided by the method according to the present invention, the security document may contain other security features, such as anti-copy patterns, guilloches, endless text, miniprint, microprint, nanoprint, rainbow colouring, 1D-barcode, 2D-barcode, coloured fibres, fluorescent fibres and planchettes, fluorescent pigments, Kinegrams™, overprint, relief embossing, perforations, metallic pigments, magnetic material, Metamora colours, microchips, RFID chips, images made with OVI (Optically Variable Ink) such as iridescent and photochromic ink, images made with thermochromic ink, phosphorescent pigments and dyes, watermarks including duotone and multitone watermarks, ghost images and security threads.

The security document may also contain OVDs provided with other techniques.

A combination with one of the above security features increases the difficulty for falsifying a security document.

### Laser Marking

The OVD or the tactile security element is provided on the security document by exposing it to a laser.

The laser is preferably a UV laser or an IR laser, more preferably an IR laser.

An UV laser has its emission wavelength in the UV region.

Preferred UV lasers have an emission wavelength between 250 and 450 nm, more preferably between 300 and 400 nm.

Preferred UV laser are the commercially available InGaN-based semiconductor laser diodes having a wavelength of approximately 405 nm.

An IR laser has its emission wavelength in the infrared (IR) region.

The infrared laser may be a continuous wave or a pulsed laser.

For example a CO₂ laser, a continuous wave, high power infrared laser having an emission wavelength of typically 10600 nm (10.6 micrometer) may be used.

CO₂ lasers are widely available and cheap. A disadvantage however of such a CO₂ laser is the rather long emission wavelength, limiting the resolution of the laser marked information.

To produce high resolution laser marked data, it is preferred to use a near infrared (NIR) laser having an emission wavelength between 780 and 2500, preferably between 800 and 1500 nm in the laser marking step.

A particularly preferred NIR laser is an optical pumped semiconductor laser. Optically pumped semiconductor lasers have the advantage of unique wavelength flexibility, different from any other solid-state based laser. The output wavelength can adjusted allowing a perfect match between the laser emission wavelength and the absorption maximum of an optothermal converting agent present in the laser markable layer.

A preferred pulsed laser is a solid state Q-switched laser. Q-switching is a technique by which a laser can be made to produce a pulsed output beam. The technique allows the production of light pulses with extremely high peak power, much higher than would be produced by the same laser if it were operating in a continuous wave (constant output) mode, Q-switching leads to much lower pulse repetition rates, much higher pulse energies, and much longer pulse durations.

The OVD or the tactile security element are preferably provided on a security document by using the same laser. However, as mentioned above, the laser parameters, such as the laser density or laser speed, may be different for producing the OVD or the tactile security element.

### EXAMPLES

### Materials

All materials used in the following examples were readily available from standard sources such as ALDRICH CHEMICAL Co. (Belgium) and ACROS (Belgium) unless otherwise specified. The water used was deionized water.

Hydran™ APX101H is a waterbased liquid of ionomer type polyester urethane using polyester segments based on terephthalic acid and ethylene glycol and hexamethylene diisocyanate available from DIC Europe GmbH.

Resorcinol from Sumitomo Chemicals.

Resor-sol is a 7.4 wt % aqueous solution of resorcinol (pH 8).

Par is a dimethyltrimethylolamine formaldehyde resin from Cytec industries.

PAR-sol is a 40 wt % aqueous solution of Par.

PEA is Tospearl 120 from Momentive Performance materials.

PEA-sol is a 10 wt % (50/50) aqueous/ethanol dispersion of PEA.

Dowfax™ 2A1 from Pilot Chemicals C is a Alkyldiphenyloxide disulfonate (4.5% wt %).

DOW-sol is a 2.5 wt % solution of Dowfax™2 A1 in isopropanol.

Solbin™ A is a copolymer of 92% vinyl chloride, 3% vinyl acetate and 5% vinyl alcohol from NISSIN CHEMICAL Co.

Solbin™ AL is a copolymer of 93% vinyl chloride, 2% vinyl acetate and 5% vinyl alcohol from NISSIN CHEMICAL Co.

Solvin™ 557 RB is a copolymer of 90% vinyl chloride and 10% vinyl acetate from SOLVAY.

Sunvac™ LPOH is a copolymer of 90% vinyl chloride, 4% vinyl acetate and 6% vinyl alcohol from WUXI HONGHUI CHEMICAL.

5-Lec™ BL-10 is a polyvinyl butyral copolymer including a hydroxyl content of 26 mol %, a buytyral content of at least 71 mol % and an acetal of maximum 3 mol % available from SEKISUI.

Tospearl™ 145 is a polymethylsilsesquioxane with an average particle size 4.5 μm from GENERAL ELECTRIC.

PVC-1 is a polyvinylchloride core (thickness=320 μm) commercially available as White card core ADE-14 from TIANJIN WEIJIA.

PVC-2 is a polyvinylchloride core (thickness=320 μm) commercially available as Pentaprint® PVC from KLOCKNER PENTAPLAST.

PVC-3 is a polyvinylchloride core (thickness=320 μm) commercially available from JIANGSU HUAXIN NEW MATERIALS.

PETG-1 is a PETG core (thickness=320 μm) commercially available as PETG-T0001 from WOLFEN.

PETG-2 is a PETG core (thickness=320 μm) commercially available as SP-180YS from JIANGSU HUAXIN NEW MATERIALS.

Teslin® SP600, a synthetic paper (thickness=152 μm) commercially available from TESLIN.

PET/PE is a PET/polyethylene overlay (thickness=75-75 μm).

CPF is transparent laser markable foil (thickness=92 μm) commercially available from Agfa Gevaert NV.

### Measurements

### Topography

The topography of laser marked images was quantitatively evaluated by means of profilometry. The samples were evaluated with a MicroSurf confocal microscope from Nanofocus using a 20× magnification.

### Example 1

### Preparation of PET-1

A coating composition SUB-1 was prepared by mixing the components according to Table 1 using a dissolver.

TABLE 1

| Components of SUB-1 | Volume (L) |
|---|---|
| deionized water | 700.9 |
| Hydran ™ APX101H | 146.6 |
| Resor-sol | 125.0 |
| PAR-sol | 5.0 |
| PEA-sol | 7.5 |
| DOW-sol | 15.0 |

After stretching a 1100 μm thick polyethylene terephthalate substrate longitudinally, the coating composition SUB-1 was coated onto the longitudinally stretched PET and dried.

The coated longitudinally stretched PET was then transversally stretched to produce a 63 μm thick transparent and glossy subbed biaxially stretched polyethylene terephthalate substrate PET-1.

The dry thickness of the subbing layer coated from SUB-1 was 211 mg/m².

### Preparation of the Overlay OL-01

The overlay OL-01 was obtained by applying a coating solution obtained by mixing the ingredients according to Table 2 using a dissolver on the subbed PET-C support PET-1 at a wet coating thickness of 80 μm and subsequently dried for 2 minutes at 20° C. on the film applicator and for a further 15 minutes in an oven.

TABLE 2

| Component | g |
|---|---|
| MEK | 280 |
| Solbin ™ A | 35 |
| Tospearl ™ 145 | 0.2 |
| S-lec BL10 | 12 |

### Preparation of the Security Documents SD-01 to SD-07

The security documents SD-01 to SD-07 were prepared by laminating the overlay OL-01 on the CORE supports according to Table 3. The lamination was performed using an Oasys OLA6/7 plate laminator with the settings: LPT=115° C., LP=40, Hold=210 sec, HPT=115° C., HP=40 and ECT=50° C.

The security documents were then cut in a standard format for ID cards.

### Laser Marking the Security Documents SD-01 to SD-07

The security documents SD-01 to SD-07 were laser marked using a Rofin RSM Powerline E laser (10 W) with settings 38 ampere and 40 kHz at 100% power.

The laser marking results are shown in Table 3.

The laser marked image was visually evaluated. Metallic stands for a metallic appearance of the laser marked image.

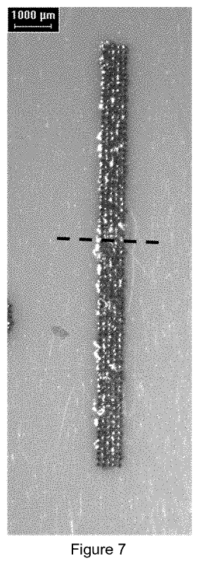

A thin line (12 mm×0.6 mm) was laser marked on the Security Documents SD-01 to SD-06. A photograph of such a laser marked thin line is shown in FIG. 7.

Round spots were laser marked on SD-07. A photograph of such a round spot is given in FIG. 6.

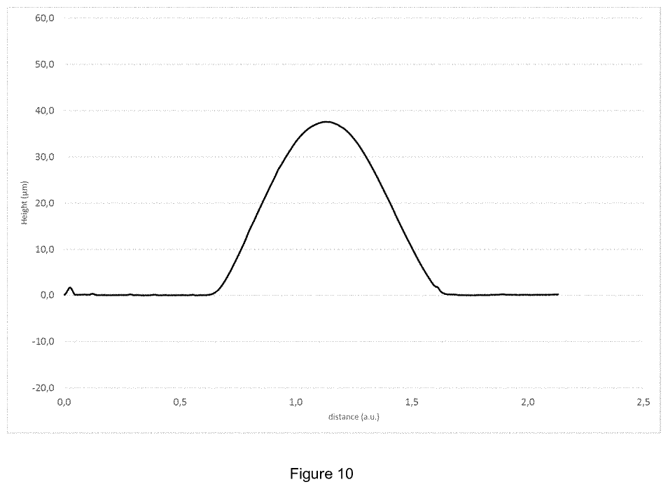

A height profile was measured of such a thin line or the round spot, as shown in FIG. 10 for the thin line of SD-03.

Table 3 shows the maximum height (Height Max) of the measured profile.

TABLE 3

| | | | | Height | |
|---|---|---|---|---|---|
| Security | CORE | | Exposure | Max | Laser |
| Document | support | Overlay | (dpi) | (μm) | Marking |
| SD-01 | PVC-1 | OL-01 | 150 | 1.5 | Metallic |
| SD-02 | PVC-1 | OL-01 | 225 | 11.1 | Metallic |
| SD-03 | PVC-1 | OL-01 | 300 | 38.5 | Metallic |
| SD-04 | PETG-1 | OL-01 | 150 | 0.9 | Metallic |
| SD-05 | PETG-1 | OL-01 | 225 | 6.5 | Metallic |
| SD-06 | PETG-1 | OL-01 | 300 | 40.0 | Metallic |
| SD-07 | PETG-1 | OL-01 | 500* | 90.0 | Metallic |

*laser settings were 29 Ampere-35 kHz. The image was exposed three times with the laser.

It is clear from the results in Table 3 that the laser marked lines all have a metallic appearance.

It is also clear from Table 3 that a tactility was created by laser marking the security documents. The maximal height measured of the laser marked profile increased as function of dpi (for the same exposure energy). An IR exposure with a higher dpi results in a higher laser energy per inch. This may result in more heat created upon laser exposure resulting in thicker laser marked lines.

### Example 2

The security documents SD-08 to SD-21 were prepared by laminating the overlays and the CORE supports according to Table 4 as described in Example 1.

The security documents were then cut in a standard format for ID cards.

Laser marking was carried out as described in example 1. The results are shown in Table 4.

TABLE 4

| | | |
|---|---|---|
| Security | CORE | Laser marked image |

| Document | support | Overlay | Appearance | Tactile |
|---|---|---|---|---|
| SD-08 | PVC-1 | — | Grey | No |
| SD-09 | PVC-1 | OL-01 | Metallic | Yes |
| SD-10 | PVC-1 | PET/PE | No | No |
| SD-11 | PVC-2 | — | Grey | No |
| SD-12 | PVC-2 | OL-01 | Metallic | Yes |
| SD-13 | PVC-3 | — | Grey | No |
| SD-14 | PVC-3 | OL-01 | Metallic | Yes |
| SD-15 | PETG-1 | — | Grey | No |
| SD-16 | PETG-1 | OL-01 | Metallic | Yes |
| SD-17 | PETG-1 | PET/PE | Grey | No |
| SD-18 | PETG-2 | — | Grey | No |
| SD-19 | PETG-2 | OL-01 | Metallic | Yes |
| SD-20 | Teslin | — | Light Grey | No |
| | SP600 | | | |
| SD-21 | Teslin | OL-01 | Metallic | No |
| | SP600 | | | |

It is clear from the results in Table 4 that an image having a metallic appearance was obtained by exposing the security documents comprising an overlay laminated on a core support, wherein the overlay comprises a layer including a vinyl chloride copolymer.

Also a tactile laser mark was obtained with such an overlay, except when the core support is a porous support, such as a Teslin SP600 support.

It is also clear that laser marking a security document comprising a core substrate including a vinyl chloride polymer without an overlay laminated on it does not result in a metallic laser marking or a tactile laser marking.

### Example 3

### Example Preparation of the Coating Compositions CC-01 to CC-08

The coating compositions CC-01 to CC-08 were prepared by mixing together the components according to Table 5 using a dissolver.

TABLE 5

| Component | | | | | | | | |
|---|---|---|---|---|---|---|---|---|
| (g) | CC-1 | CC-2 | CC-3 | CC-4 | CC-5 | CC-6 | CC-7 | CC-8 |
| MEK | 750 | 720 | 725 | 695 | 675 | 680 | 735 | 710 |
| Solbin ™ A | 70 | = | = | — | — | — | — | — |
| Solbin ™ | — | — | — | 125 | = | = | — | — |
| AL | | | | | | | | |
| Solvin ™ | — | — | — | — | — | — | 85 | — |
| 557RB | | | | | | | | |
| Sunvac ™ | — | — | — | — | — | — | — | 110 |
| LPOH | | | | | | | | |
| Tospearl ™ | 0.05 | = | = | = | = | = | = | = |
| 145 | | | | | | | | |
| S-lec BL10 | — | 30 | 25 | — | 45 | 40 | — | — |
| Carbon | — | — | 0.2 | — | — | 0.5 | — | — |
| Black | | | | | | | | |

### Preparation of the Overlays OL-02 to OL-09

The coating compositions CC-1 to CC-8 were coated with an Elcometer Bird Film Applicator (from ELCOMETER INSTRUMENTS) on the subbed PET-C support PET-1 at a wet coating thickness of 80 μm and subsequently dried for 2 minutes at 20° C. on the film applicator and for a further 15 minutes in an oven at 50° C. to deliver the security overlays OL-2 to OL-9.

### Preparation of the Security Documents SD-22 to SD-29

The overlays OL-02 to OL-09 were each laminated on a 500 μm opaque PETG core, available as PET-G 500 type 9311 from WOLFEN, resulting in the security documents SD-22 to SD-29. The lamination was performed using an Oasys OLA6/7 plate laminator with the settings: LPT=115° C., LP=40, Hold=210 sec, HPT=115° C., HP=40 and ECT=50° C.

The security documents were then cut in in a standard format for ID cards.

### Laser Marking the Security Documents SD-22 to SD-29

The security documents SD-22 to SD-29 were laser marked using a Rofin RSM Powerline E laser (10 W) with settings 36 ampere and 30 kHz at 100% power.

The laser marking results are shown in Table 6. In Table 6 it is indicated whether or not a laser marked image having a metallic appearance was obtained. In addition, the resolution of the laser marked image was visually evaluated as follows:

TABLE 6

| Security | Metallic | |
|---|---|---|
| Documents | Image | Resolution |
| SD-22 | Yes | + |
| SD-23 | Yes | ++ |
| SD-24 | Yes | +++ |
| SD-25 | Yes | + |
| SD-26 | Yes | ++ |
| SD-27 | Yes | +++ |
| SD-28 | Yes | + |
| SD-29 | Yes | + |

+ sufficient resolution
++ good resolution
+++ very good resolution

From Table 6, it should be clear that with all security documents comprising an overlay laminated on a core support, wherein the overlay comprises a layer including a vinyl chloride copolymer, an image having a metallic look was obtained upon laser marking.

It is also clear that the addition of a copolymer of vinyl butyral in addition to the vinyl chloride copolymer results in a better resolution of the metallic image (see SD-23 and SD-26).

This resolution is even more improved by adding carbon black (see SD-24 and SD-27).

### Example 4

### Preparation of the Security Documents SD-30 to SD-33

The security documents SD-30 to SD-33 were prepared by laminating the overlays and the CORE supports according to Table 7 as described in Example 1.

The security documents were then cut in a standard format for ID cards.

TABLE 7

| | | | Laser |
|---|---|---|---|
| | | | marked |
| Security | CORE | | image |
| Document | support | Overlay | Appearance |
| SD-30 | PETG-1 | OL-01 | Metallic |
| SD-31 | PETG-1 | OL-01 | Metallic |
| SD-32 | PC | PC | Grey |
| SD-33 | CPF-PETG-1 | OL-01 | Grey |

SD-32 is a full polycarbonate security document (760 μm) wherein both the overlay and core consist of polycarbonate from Covestro.

SD-33 is a security document wherein the overlay OL-01 is laminated on a core, which consist of CPF and PETG-1. The overlay is laminated on top of the CPF foil.

The security documents were then cut in in a standard format for ID cards and laser marked using a Rofin RSM Powerline E laser (10 W) with settings 38 ampere and 40 kHz at 100% power for SD-30 and SD-31 and 25 ampere and 30 kHz at 100% power for SD-32 and SD-33.

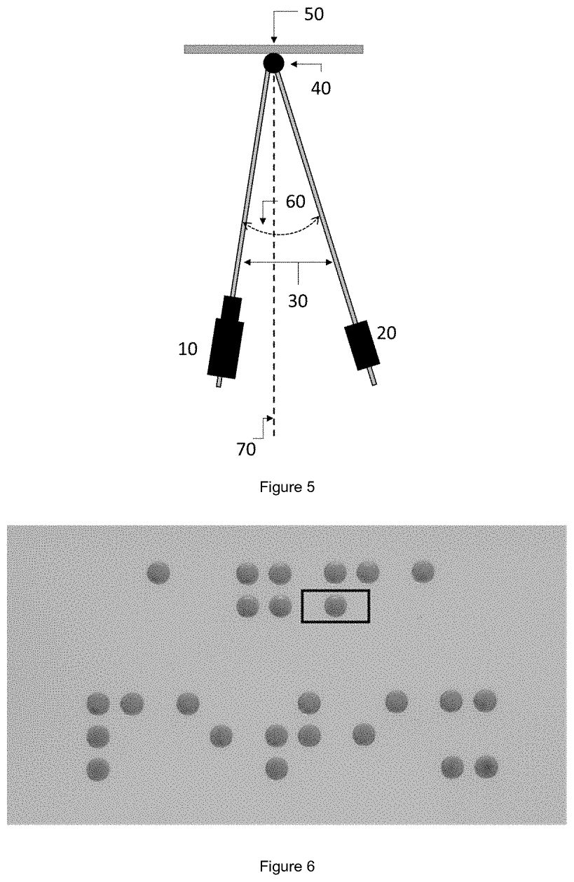

To evaluate the laser marked OVD, an image capture setup was used having the following elements:
an image digitization element (for example a camera, FIG. 5, (10)) capable of capturing an image with an intensity range of at least 12 bit with a suitable lens;
a point light source with an aperture angle of ±30° (FIG. 5, (20)); and
a stand for the (card) material under inspection (FIG. 5, (50).

The elements described above are arranged in such a manner that:
the angle between the direction of observation by the camera (10) and the surface normal of the material (70) may be varied between −10° and 0°. The measurement described below were carried out at a fixed angle of −6.7°;
the light source (20) may be positioned at various angles. By moving the light source (20), the angle between the direction of illumination and the direction of observation by the camera (60) could be varied from ca. +20° upto +70°;
the camera was focused on the laser marked parts of the material;
as the light source was rotated to a different angle, it kept pointing at the same spot on the material.

The image capturing setup used to evaluate the laser marked images is schematically shown in FIG. 5.

The camera (10) and light source (20) are each mounted on a rail (30). Both rails, i.e. the camera arm and the light source arm, come together in a center-of-rotation (40) at the location of the sample (50). In the current setup, the camera “looks” at the sample at an angle of −6.7°, relative to the surface normal of the material (60).

The camera was not moved. The rail of the light source on the other hand was rotated to a different angle for each image captured. In this way, a series of images was captured, representing an angular scan of how the sample “looks like” as the angle of the light source changes, whilst keeping the angle of observation constant. As the rail of the light source rotates, the light source still shines directly onto the sample.

The exposure conditions for image capture, including intensity of illumination and shutter time of the camera, were chosen to not introduce clipping of glossy reflections arising from the gloss structure under inspection. That is why a dynamic range of 12 bits was preferred.

The field-of-view of the camera is large enough to enclose the 2 AOI's, used for obtaining the angular ratio curve.

The addressability (often labeled as resolution) of the captured imaged must be higher or equal to 500 dpi (dots-per-inch). I.e. 50 μm/pixel or smaller.

The Relative angle is the angle between the direction of illumination and the direction of observation by the camera (FIG. 5, (60).

The AOI's are selected in those parts of the laser marked image, whose visibility changes, relative to each other, as function of the relative angle (viewing angle). For example, a first AOI may consist of a collection of all pixels inside a rhombus (FIG. 4, (300) while the other AOI may consist of all pixels inside a character in or outside the rhombus (FIG. 4, (350).

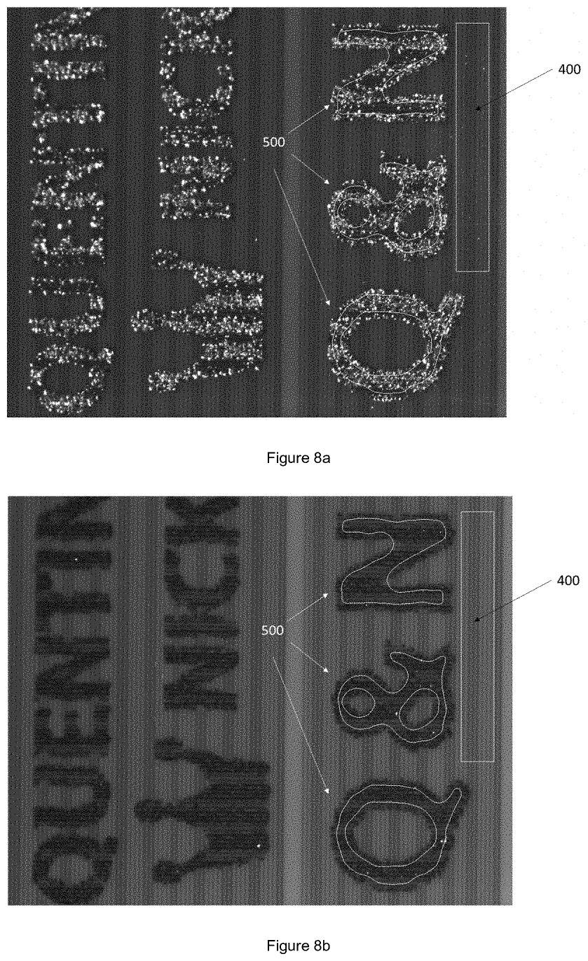

For example, the two AOI's selected to evaluate the laser marked OVD on SD-30 are shown in FIG. 8 for two relative angles (29.1° in FIGS. 8a and 68.1° in FIG. 8b). The first AOI is selected inside a laser marked character (500) while the second AOI is selected in the background (400) of the laser marked image.

If an AOI has a certain texture inside, then the AOI has to be large enough to encompass 1 or more repetitions of that texture. E.g. referring to FIG. 8a, the texture inside AOI (500) consists of many tiny glossy speckles as well as many small darker areas in between the glossy speckles. AOI (500) encompasses many repetitions of those texture elements, and thus the average grey level of all pixels inside AOI (500) represents well the overall brightness of the characters in AOI (500). That would not be the case if AOI (500) would only contain the glossy speckles. The area of an AOI must be minimally large enough to be resolved by the unaided human eye at a viewing distance of 25 cm or more, i.e. minimally 200×200 μm.

To realize an angular ratio curve, a collection of digital images of the material as a function of relative angle was taken. To realize a set of N relative angles from ca. +20° upto ca. +70°, for example 10 to 15 different angles in that range, light source (20) is positioned sequentially at each of those N angles to capture an image. This results in a collection of N images, which can be combined into a small movie of N frames.

To calculate the angular ratio curve, two AOI's inside a laser marked image are selected. The grey levels of both AOI's are calculated for all N frames in the angular scan. A plot of the ratio of both gray levels as a function of relative angle is called the angular ratio curve.

As the angular position of the camera is not changed during the angular scan (only the light source is moved), the scene that the camera “sees” remains the same throughout the angular scan. Therefore, both AOI's can be defined once in any of the N frames and can then be kept constant while calculating the grey level for all N frames.

For example, the two AOI's selected to evaluate the laser marked images are shown in FIG. 8 for two relative angles (29.1° in FIG. 8a and 68.1° in FIG. 8b). The first AOI is selected inside a laser marked character (500) while the second AOI is selected in the background (400) of the laser marked image.

It is clear from FIG. 8 that the appearance of especially the characters (FIG. 8, (500) changes as function of the relative angle (viewing angle).

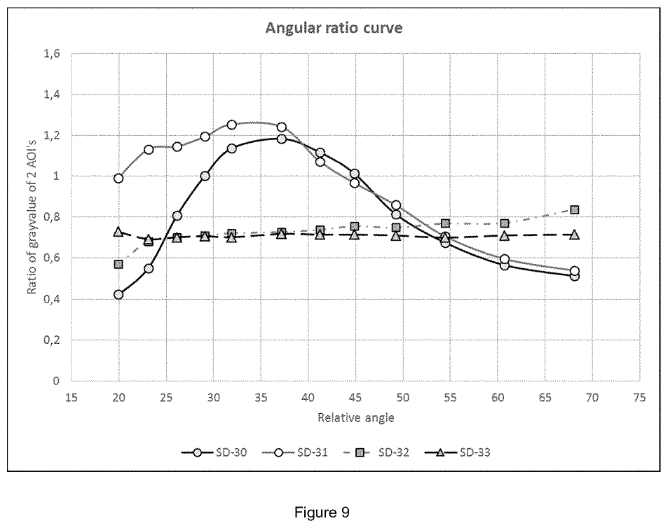

In FIG. 9, the angular ratio curve is given for the laser marked security documents SD-30 to S-33.

The angular ratio curves of the laser marked images having OVD properties (SD-30 and SD-31) are very different to those of the images having no OVD properties (SD-32 and SD-33).

The angular ratio curve of SD-30 and SD-31 are characterized by large variations of the ratio of the grey levels at different relative angles, i.e. viewing angle. The ratio of the grey levels also have values both above and below 1.

This indicates that the grey levels of the AOI's do show a large variation relative to each other as function of the relative angle (viewing angle).

1-15. (canceled)

16. A method of providing an optical variable device or a tactile security element on a security document, the method comprising:
exposing the security document with a laser; wherein
the security document includes an overlay provided on a core; and
the overlay includes a component that is able to form a gas upon being exposed by the laser.

17. The method according to claim 16, wherein the optical variable device or the tactile security element has a metallic appearance.

18. The method according to claim 16, wherein the optical variable device includes a first image and a second image, and a ratio of an average grey level of the first image and the second image varies as a function of a viewing angle of the optical variable device.

19. The method according to claim 18, wherein a difference between the ratio of the average grey level of the first image and the second image at two different viewing angles is at least 0.3.

20. The method according to claim 18, wherein the ratio of the average grey level of the first image and the second image is more than 1.1 at a first viewing angle and less than 0.9 at a second viewing angle.

21. The method according to claim 19, wherein the ratio of the average grey level of the first image and the second image is more than 1.1 at a first viewing angle and less than 0.9 at a second viewing angle.

22. The method according to claim 16, wherein a height of the tactile security element is at least 0.15 μm.

23. The method according to claim 16, wherein the optical variable device and the tactile security element are obtained by exposing the security document with the laser.

24. The method according to claim 16, wherein the overlay includes an adhesive layer provided on a transparent support, and the adhesive layer includes the component able to form the gas upon being exposed by the laser.

25. The method according to claim 24, wherein the transparent support includes transparent biaxially stretched polyethylene terephthalate.

26. The method according to claim 16, wherein the core includes polyvinylchloride, polycarbonate, or polyethylene terephthalate.

27. The method according to claim 16, wherein the compound able to form the gas upon being exposed by the laser is a halogenated homo- or copolymer.

28. The method according to claim 24, wherein the adhesive layer further includes a laser additive.

29. The method according to claim 24, wherein the adhesive layer further includes a copolymer of vinyl butyral, vinyl acetate, and vinyl alcohol.

30. The method according to claim 28, wherein the adhesive layer further includes a copolymer of vinyl butyral, vinyl acetate, and vinyl alcohol.

31. The method according to claim 16, wherein the laser is an infrared laser.

32. A security document comprising:
the optical variable device or the tactile security element obtained by the method according to claim 16.
